(19) United States
(12) Patent Application Publication
(10) Pub. No.: US 2015/0258939 A1
(43) Pub. Date: Sep. 17, 2015

(54) FLEXIBLE INTERIOR TRIM COMPONENT

(71) Applicants: Jason M. HIPSHIER, Hudsonville, MI (US); Ronald A. BOZIO, Holland, MI (US); Kenneth D. SHERBURN, Grandville, MI (US); Michael CATLIN, Holland, MI (US)

(72) Inventors: Jason M. Hipshier, Hudsonville, MI (US); Ronald A. Bozio, Holland, MI (US); Kenneth D. Sherburn, Grandville, MI (US); Michael R. Catlin, Holland, MI (US)

(73) Assignee: Johnson Controls Technology Company, Holland, MI (US)

(21) Appl. No.: 14/440,041

(22) PCT Filed: Nov. 1, 2012
(86) PCT No.: PCT/US12/62949

§ 371 Date: Apr. 30, 2015

(51) Int. Cl. B60R 7/04; B60R 13/02

(52) U.S. Cl. CPC B60R 7/04; B60R 13/0262

(57) ABSTRACT

An interior trim component includes a substrate having a first rib positioned adjacent to an axial end of the interior trim component. The interior trim component also includes multiple second ribs each oriented substantially parallel to the first rib. The first rib and each second rib are configured to engage a track to facilitate movement of the interior trim component along the track. The interior trim component further includes a cushion coupled to the second ribs and to the substrate. The cushion extends along a first surface of the substrate, wraps around the first rib, and engages a second surface of the substrate, opposite the first surface, to form the axial end of the interior trim component.

### BACKGROUND

The invention relates generally to a flexible interior trim component for a vehicle.

Vehicle storage compartments may be positioned throughout an interior of a vehicle to store cargo and other small items. For example, an overhead console may include a storage compartment suitable for storing sunglasses, driving glasses, or other items. Other storage compartments may be located within a center console, an armrest, seats, door panels, or other areas of the vehicle interior. Certain storage compartments include a door configured to secure the contents of the compartment and/or hide the contents from view.

While a variety of door configurations may be employed, tambour doors are generally well-suited for storage compartments having curved openings. Typical tambour doors include a series of interlocked parallel ribs or segments that may rotate with respect to one another. In this manner, the tambour door may flex in a direction perpendicular to the orientation of the parallel segments. Such a configuration may enable the tambour door to match the contours of the curved storage compartment opening, thereby facilitating movement of the tambour door with respect to the storage compartment opening. Unfortunately, because the ribs are generally constructed from substantially rigid material, the show surface of the tambour door may be hard and/or stiff In addition, recesses between the ribs may collect dirt and/or other contaminants, thereby degrading the appearance of the door. Alternatively, the ribs may be coupled to a flexible carrier configured to enable the tambour door to bend in a direction perpendicular to an orientation of the ribs. Unfortunately, because the flexible carrier is typically constructed from substantially hard material, the show surface of the tambour door may have an undesirable firmness and/or appearance.

### BRIEF DESCRIPTION OF THE INVENTION

The present invention relates to an interior trim component including a substrate having a first rib positioned adjacent to an axial end of the interior trim component. The interior trim component also includes multiple second ribs each oriented substantially parallel to the first rib. The first rib and each second rib are configured to engage a track to facilitate movement of the interior trim component along the track. The interior trim component further includes a cushion coupled to the second ribs and to the substrate. The cushion extends along a first surface of the substrate, wraps around the first rib, and engages a second surface of the substrate, opposite the first surface, to form the axial end of the interior trim component.

The present invention also relates to an interior trim component including multiple substantially parallel ribs each configured to engage a track to facilitate movement of the interior trim component along the track. The interior trim component also includes a cushion having an outer surface, a rear surface, and a contoured lateral end extending between the outer surface and the rear surface. The outer surface is configured to face an interior of a vehicle, the rear surface is coupled to the substantially parallel ribs, the contoured lateral end forms a projection adjacent to the rear surface, and the projection is configured to extend laterally outward beyond an inner surface of a structure that surrounds the interior trim component.

The present invention further relates to an interior trim component including multiple substantially parallel ribs each configured to engage a track to facilitate movement of the interior trim component along the track. The interior trim component also includes a cushion having an outer surface and a rear surface. The outer surface is configured to face an interior of a vehicle, the rear surface is coupled to the substantially parallel ribs, and a portion of at least one rib is embedded within the rear surface.

The present invention relates to a vehicle interior assembly including a tambour door having multiple substantially parallel ribs, and a cushion coupled to the substantially parallel ribs. The vehicle interior assembly also includes a support structure having a track configured to receive the substantially parallel ribs, and an interior wall that defines a storage compartment. Each rib is configured to engage the track to facilitate movement of the tambour door between an open position that facilitates access to the storage compartment and a closed position that blocks access to the storage compartment, and a distal end of the wall is positioned adjacent to the track to block movement of the tambour door toward the storage compartment via contact between the distal end of the wall and the substantially parallel ribs.

The present invention further relates to an interior trim component including multiple substantially parallel ribs, and corresponding protrusions extending laterally outward from the substantially parallel ribs. Each protrusion is configured to engage a track to facilitate movement of the interior trim component along the track. The interior trim component also includes a cushion having an outer surface and a rear surface. The outer surface is configured to face an interior of a vehicle, and the rear surface is coupled to a mounting surface of each rib. The cushion includes a lateral projection spaced from the protrusions, and extending laterally outward beyond the mounting surface of each rib.

The present invention relates to an interior trim component including multiple substantially parallel ribs each configured to engage a track to facilitate movement of the interior trim component along the track. The interior trim component also includes a cushion having an integral outer skin. The cushion is coupled to the substantially parallel ribs, and the integral outer skin forms a first show surface of the interior trim component. The interior trim component further includes a decoration formed within the integral outer skin. The decoration includes a second show surface, and a first height of the first show surface relative to the substantially parallel ribs is different than a second height of the second show surface relative to the substantially parallel ribs.

### DRAWINGS

FIG. 1 is a perspective view of an exemplary vehicle that may include one or more storage compartments each having a flexible tambour door.

FIG. 2 is a perspective view of an exemplary center console that may be located within an interior of the vehicle of FIG. 1.

FIG. 3 is a perspective view of the center console of FIG. 2 with a flexible tambour door in an open position.

FIG. 4 is a perspective view of an embodiment of a flexible tambour door with an integral skin show surface that may be employed within the center console of FIG. 2.

FIG. 5 is a cross-sectional view of the flexible tambour door of FIG. 4, taken along line 5-5.

FIG. 6 is a perspective view of another embodiment of a flexible tambour door with a cover layer that may be employed within the center console of FIG. 2.

FIG. 7 is a cross-sectional view of the flexible tambour door of FIG. 6, taken along line 7-7.

FIG. 8 is a cross-sectional view of a further embodiment of a flexible tambour door with a cover layer, having a cushion without an integral outer skin.

FIG. 9 is a cross-sectional view of an embodiment of a flexible tambour door having a cushion that wraps around an axial end of a substrate.

FIG. 10 is a cross-sectional view of another embodiment of a flexible tambour door having ribs partially embedded within a cushion.

FIG. 11 is a cross-sectional view of a further embodiment of a flexible tambour door including a cushion having a contoured lateral end.

FIG. 12 is a perspective view of another embodiment of a flexible tambour door having a decoration formed within a show surface.

FIG. 13 is a cross-sectional view of a further embodiment of a flexible tambour door having a cushion that extends laterally outward beyond a mounting surface of each supporting rib.

FIG. 14 is a cross-sectional view of an embodiment of a flexible tambour door having a supporting rib with a mounting feature embedded within a rear surface of a cushion.

FIG. 15 is a detailed perspective view of an embodiment of protrusions that may extend from supporting ribs of a flexible tambour door.

### DETAILED DESCRIPTION

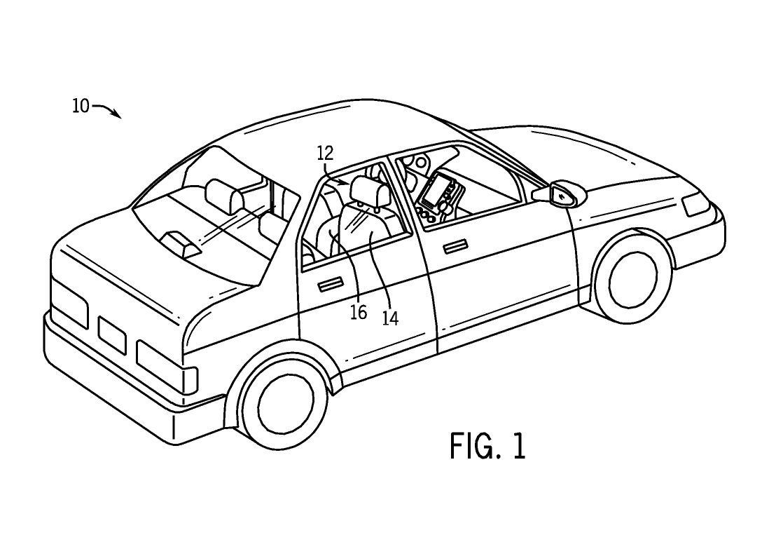

FIG. 1 is a perspective view of an exemplary vehicle 10, including an interior 12 having seats 14 and a center console 16. As discussed in detail below, the center console 16 and/or other areas within the interior 12 may include a flexible interior trim component, such as a flexible door enclosing a storage compartment. For example, certain storage compartments may employ a flexible tambour door having multiple substantially parallel ribs. These ribs may be configured to engage a track, thereby facilitating movement of the tambour door along an opening of the storage compartment. The tambour door may also include a cushion having a rear surface facing an interior of the storage compartment, and a show surface (e.g., formed from an integral outer skin) facing the interior 12 of the vehicle 10. Alternatively, an outer surface of the cushion may be wrapped with a cover layer to form the show surface of the flexible tambour door. The rear surface may be coupled to the substantially parallel ribs such that the tambour door may flex in a direction perpendicular to the orientation of the substantially parallel ribs. Such a configuration may enable the tambour door to match the contours of a curved storage compartment opening, thereby facilitating movement of the tambour door with respect to the storage compartment opening.

As will be appreciated, typical tambour doors include a series of interlocked or otherwise joined parallel ribs or segments that may rotate with respect to one another. To facilitate tambour door segment rotation, a recess in the show surface may be positioned adjacent to each segment. These recesses may collect dirt and/or other contaminants, thereby degrading the appearance of the door. In addition, as the tambour door flexes, adjacent segments may rotate toward one another, thereby reducing the width of the intervening recesses. The decreasing width of the recesses may establish undesirable pinch points between adjacent segments. Furthermore, because the segments are generally constructed from substantially rigid material, the show surface of the tambour door may be hard and/or stiff. By providing a cushion having an integral outer skin and/or a cover layer, the present embodiments may eliminate these recesses and establish a soft show surface. As a result, any dirt or other contaminants which collect on the surface of the tambour door may be easily removed. In addition, the possibility of pinching between segments may be substantially reduced or eliminated. Furthermore, the cushioned show surface may enable the tambour door to serve as an armrest for vehicle occupants, thereby reducing the space utilized by a separate armrest and storage compartment door.

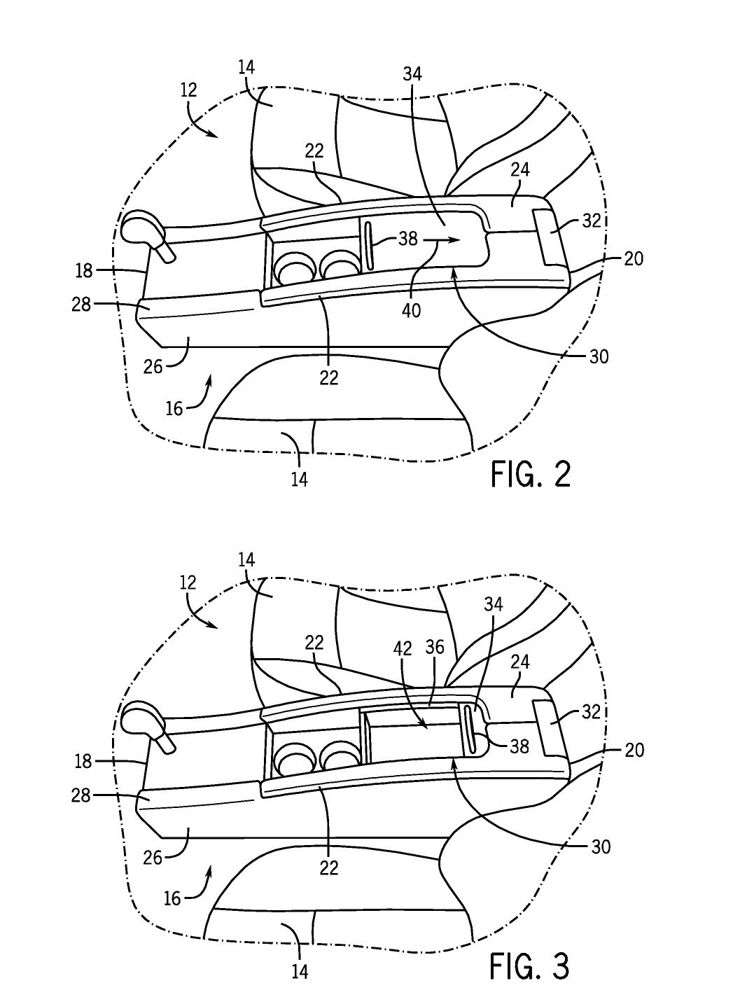

FIG. 2 is a perspective view of an exemplary center console 16 that may be located within an interior of the vehicle shown in FIG. 1. As discussed in detail below, the center console 16 may include a storage compartment enclosed by a flexible tambour door. As illustrated, the console 16 is coupled to a floor of the vehicle interior 12 between a driver seat 14 and a passenger seat 14. In the present configuration, the console 16 is configured to provide a storage area and an armrest for an occupant of one or both seats 14. The console 16 is generally prismatic, having a front wall 18, a rear wall 20, two opposed and generally symmetrical side walls 22 and a top surface 24.

The console 16 also includes two side panels 26 which form the main body of the console 16. In the present configuration, each side panel 26 provides one of the side walls 22 of the console 16 and portions of the rear wall 20, the front wall 18 and the top surface 24. As illustrated, the side walls 22 include a compound-curved upper contour having both convex and concave portions, thereby transitioning between the raised rear wall 20 and the lower front wall 18. The top edges 28 of the side panels 26 form the curved top surface 24. The top surface 24 includes an opening 30 that enables an occupant to access an interior of the console 16. In certain configurations, the console 16 includes a rear panel 32 forming a portion of the rear wall 20 and/or the top surface 24.

In the present configuration, the console 16 includes a door 34 configured to transition between an open position and the illustrated closed position. The door 34 includes a handle 38 that enables an occupant to slide the door 34 between the two positions. As discussed in detail below, sliding the door 34 toward the open position in the direction 40 exposes an interior of a storage compartment located within the console 16. In certain configurations, the door 34 is a tambour door having a series of substantially parallel ribs coupled to a cushion. The ribs are configured to engage a track within the side walls 22, while the cushion enables the door 34 to flex and to accommodate the contours of the opening 30. The cushion also enables the door 34 to serve as an armrest for the vehicle occupants, thereby reducing the space associated with providing a separate door 34 and armrest.

While the present tambour door is described with reference to the center console 16, it should be appreciated that alternative embodiments may employ similar tambour doors positioned throughout the interior 12 of the vehicle 10. For example, a storage compartment located within an overhead console, door panel, instrument panel, or other region of the interior 12 may include a flexible tambour door. Furthermore, other flexible interior trim components, in addition to the doors described above, may include similar parallel ribs coupled to a cushion.

FIG. 3 is a perspective view of the center console 16 of FIG. 2 with the flexible tambour door 34 in an open position. As illustrated, the side walls 22 include rails or tracks 36 configured to facilitate movement of the door 34 in the direction 40. In certain configurations, the tracks 36 include a C-shaped cross section, and may be coupled to the side panels 26 or integrally formed within the side panels 26. As discussed in detail below, the substantially parallel ribs of the tambour door 34 include protrusions which engage the tracks 36 and support the door 34, while the attached cushion enables the door 34 to flex, thereby accommodating the contours of the opening 30. As illustrated, transitioning the door 34 to the open position exposes an interior 42 of the storage compartment within the center console 16.

As will be appreciated, a vehicle occupant may close the door 34 by grasping the handle 38 and moving the door 34 toward the front wall 18 of the center console 16. Because the surface of the door 34 facing the interior 12 of the vehicle 10 is formed by the cushion, or a cover layer wrapped around the cushion, the possibility of being pinched by segments of the door 34 may be substantially reduced or eliminated. Once in the closed position, the cushioned show surface of the door 34 may provide a suitable surface for an armrest.

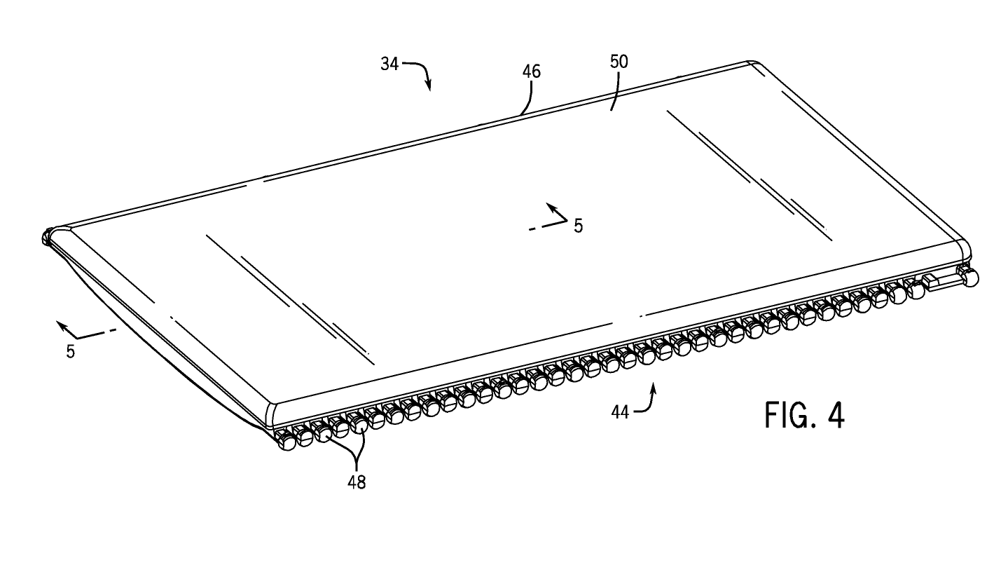

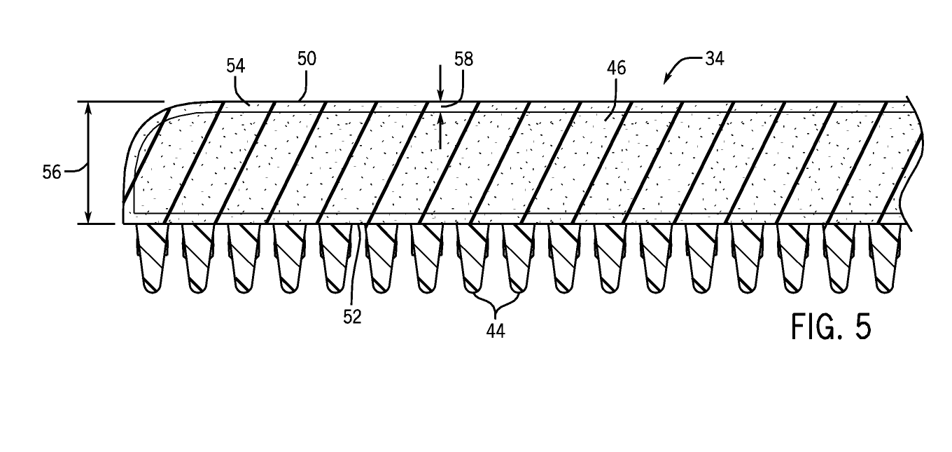

FIG. 4 is a perspective view of an embodiment of a flexible tambour door with an integral skin show surface that may be employed within the center console of FIG. 2. As illustrated, the flexible door 34 includes multiple substantially parallel ribs 44 coupled to a padded substrate or cushion 46. The ribs 44 are configured to engage the tracks 36 of the console 16 to support the door 34 and to facilitate movement of the door 34 across the opening 30. In the illustrated embodiment, the ribs 44 include protrusions 48 configured to interlock with a corresponding recess within each track 36. As discussed in detail below, the ribs 44 are coupled to a rear surface of the cushion 46 facing the interior 42 of the console 16, thereby forming a unitary structure. In this configuration, the door 34 may flex in a direction perpendicular to the orientation of the substantially parallel ribs 44, thereby enabling the tambour door to match the contours of a curved storage compartment opening. Furthermore, the cushion 46 includes an integral outer skin that forms an outer surface/show surface 50 and provides a smooth, consistent appearance to the outer surface of the flexible door 34.

As discussed in detail below, the ribs 44 may be formed by an injection molding process, and may therefore be composed of any suitable material for injection molding. For example, the ribs 44 may be composed of a thermoplastic polymer, such as polyamide, polycarbonate, or acrylonitrile butadiene styrene. It should be appreciated that the ribs 44 may be composed of other materials suitable for injection molding in alterative embodiments. In addition, the ribs 44 may include a chemical blowing agent and/or any other suitable additives.

In certain embodiments, the cushion 46 is formed by a molding process in which two reactive foam compounds are mixed and poured into an open mold having the desired shape of the cushion 46. The mold is then closed and the mixture is allowed to expand and cure. By placing the ribs 44 into the mold prior to pouring the foam, the foam bonds to the ribs 44 during the curing process. As a result, a unitary flexible component will be formed. Furthermore, material chemistry as well as temperature variations within the mold induce a high density flexible outer skin to form on the outer surface of the low density foam cushion. The resulting cushion 46 has a substantially smooth or textured integral outer skin, while providing sufficient flexibility to enable the tambour door 34 to accommodate the contours of the curved storage compartment opening 30. A layer of paint may be applied to the mold before the foam compounds are injected. The paint bonds with the foam adjacent to the inner surface of the mold, thereby establishing a desired color of the flexible outer skin. For example, the color of the outer skin may be selected to match the color of a fabric seat covering.

As previously discussed, the flexible door 34 may include a handle configured to facilitate movement of the door 34 between the open and closed positions. The handle may be attached to the door 34 by fasteners (e.g., bolts, screws, etc.) or injection molded along with the ribs 44. In configurations in which the handle is formed by injection molding, the foam may be poured over the plastic handle to establish a consistent appearance, or poured around the handle to provide a firm gasping surface. As will be appreciated, alternative embodiments may employ other components (e.g., knobs, recesses, etc.) in place of the handle to control movement of the door 34. For example, certain embodiments may include a handle formed by establishing a depression or recess into the cushion 46.

In contrast to tambour door configurations having segmented show surfaces, the flexible door 34 of the present embodiments does not include separate segments that rotate relative to one another. Instead, the cushion 46 is flexible, allowing the ribs 44 to move relative to one another while maintaining a unitary visual appearance of the flexible door 34. In addition, the cushion 46 establishes a soft show surface 50, thereby enabling the tambour door 34 to serve as an armrest for vehicle occupants. The cushion 46 also substantially reduces or eliminates the recesses between segments that may cause pinching and collection of dirt and/or other debris. Furthermore, the integral outer skin of the cushion 46 may be suitable for application of a decorative layer that may enhance the visual appearance of the tambour door 34.

FIG. 5 is a cross-sectional view of the flexible tambour door of FIG. 4, taken along line 5-5. As illustrated, the ribs 44 are coupled to a rear surface 52 of the cushion 46 which faces the interior 42 of the console 16. As previously discussed, the ribs 44 may be formed by an injection molding process. As will be appreciated, injection molding involves injecting liquid resin into a mold to form a completed part. Once the ribs 44 have been formed, the ribs 44 may be placed into a mold having a cavity shaped to form the cushion 46. Foam may then be poured into the mold. As the foam expands and cures, the foam bonds to the ribs 44, thereby forming a unitary structure including the ribs 44 and the cushion 46. In addition, due to the material chemistry and temperature variations within the mold, a high density flexible outer skin 54 is formed around the low density foam cushion 46. The integral outer skin 54 serves to protect the foam cushion 46, while providing a desirable appearance to the tambour door 34.

A thickness 56 of the cushion 46 may be configured to facilitate bending of the door 34 in a direction substantially perpendicular to an orientation of the substantially parallel ribs 44, while establishing a cushioned surface suitable for use as a vehicle armrest. As will be appreciated, thicker cushions 46 may provide an armrest with enhanced comfort, while thinner cushions 46 facilitate additional flexibility. For example, in certain embodiments, the thickness 56 may be greater than approximately 5 mm. By way of example, the thickness 56 may be approximately between 5 to 20, 7 to 16, 8 to 11, or about 9 mm. In addition, a thickness 58 of the integral outer skin 54 may be particularly selected to enable the skin to flex as the cushion 46 is compressed. For example, the thickness of the integral outer skin 54 may be less than approximately 2, 1.5, 1, 0.5, 0.3, 0.2, or 0.1 mm, or less.

In certain embodiments, the cavity which forms the cushion 46 may have a substantially smooth surface, thereby establishing a substantially smooth show surface 50 of the integral outer skin 54. As will be appreciated, smoothness may be defined by dimensional variations within the show surface 50 of the cushion 46. For example, dimensional variations within the show surface 50 may be between approximately 0.5 to 0.01, 0.3 to 0.03, 0.2 to 0.05, or about 0.1 mm. By further example, dimensional surface variations may be less than approximately 0.5, 0.3, 0.2, 0.1, 0.05, 0.03, or about 0.01 mm. Such a smooth surface 50 may enhance the appearance of the vehicle interior 12 and/or facilitate application of a decoration. In alternative embodiments, the cavity which forms the cushion 46 may have a textured surface, thereby establishing a textured show surface 50 of the integral outer skin 54. In further embodiments, the integral outer skin 54 may simulate the appearance of a tambour door having a series of interlocked parallel segments. For example, the cavity which forms the cushion 46 may have a series of parallel ridges that form corresponding parallel recesses in the integral outer skin 54. Such a configuration may provide the appearance of a segmented tambour door without creating the undesirable pinch points between segments.

In certain embodiments, the tambour door 34 may include a decorative layer disposed onto the show surface 50 of the integral outer skin 54, and a top coat layer disposed onto the decorative layer and bonded to the outer skin 54. The top coat layer is configured to flex with the outer skin 54 while substantially maintaining continuity across the show surface 50. For example, the integral outer skin 54 may simulate the appearance of a fabric skin by employing a surface finish that looks like a fabric pattern in conjunction with a textured outer skin. Such a configuration may increase the visual appeal of the tambour door 34, while reducing manufacturing costs compared to employing a separate skin.

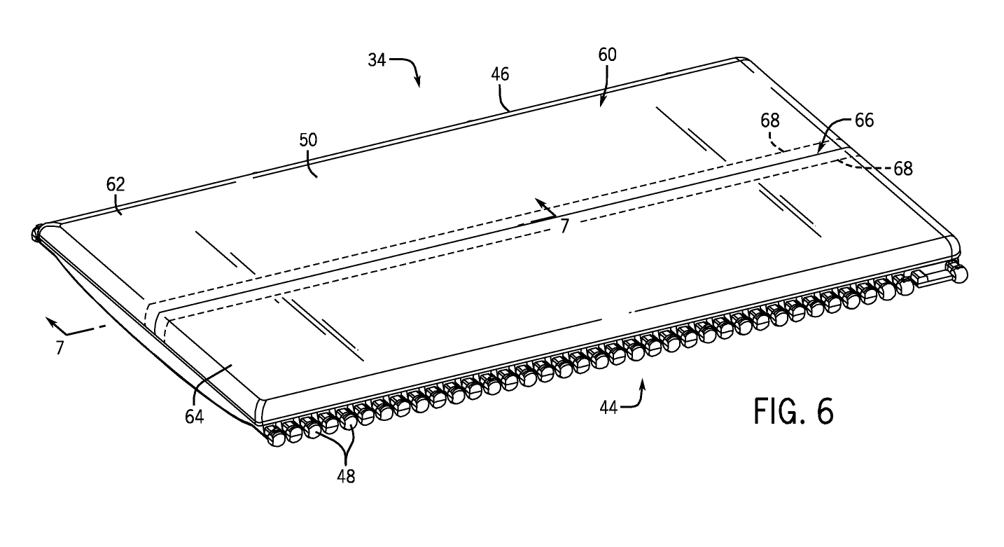

FIG. 6 is a perspective view of another embodiment of a flexible tambour door with a cover layer that may be employed within the center console of FIG. 2. Similar to the embodiment described above with reference to FIG. 4, the flexible door 34 includes multiple substantially parallel ribs 44 coupled to a cushion 46. The ribs 44 are configured to engage the tracks 36 of the console 16 to support the door 34 and to facilitate movement of the door 34 across the opening 30. In the illustrated embodiment, the ribs 44 include protrusions 48 configured to interlock with a corresponding recess within each track 36. As discussed in detail below, the ribs 44 are coupled to a rear surface of the cushion 46 facing the interior 42 of the console 16, thereby forming a unitary structure. In this configuration, the door 34 may flex in a direction perpendicular to the orientation of the substantially parallel ribs 44, thereby enabling the tambour door to match the contours of a curved storage compartment opening. Furthermore, the cushion 46 includes a cover layer 60 having a show surface that provides a smooth, consistent appearance to the outer surface of the flexible door 34.

Similar to the embodiment described above with reference to FIG. 4, the cushion 46 may be formed by a molding process. In certain embodiment, material chemistry and temperature variations within the mold may induce a high density flexible outer skin to form on the outer surface of the low density foam cushion. In other embodiments, various foam compounds and/or temperatures may be used that substantially reduce or eliminate the possibility of forming the high density flexible outer skin on the outer surface of the low density foam cushion. In such embodiments, the entire cushion 46 may have a substantially uniform low density.

In contrast to tambour door configurations having segmented show surfaces, the flexible door 34 of the present embodiment does not include separate segments that rotate relative to one another. Instead, the cushion 46 is flexible, allowing the ribs 44 to move relative to one another while maintaining a unitary visual appearance of the flexible door 34. In addition, the flexible door 34 includes a cover layer 60 secured to the outer surface of the cushion, thereby enabling the tambour door 34 to serve as an armrest for vehicle occupants. The cover layer 60 also substantially reduces or eliminates the recesses between segments that may cause pinching and collection of dirt and/or other debris. Furthermore, the cover layer 60 may include materials and/or configurations that enhance the visual appearance of the tambour door 34. For example, in certain embodiments, the cover layer 60 may be manufactured from leather, vinyl, fabric (either woven or non-woven) and/or various other materials.

In the illustrated embodiment, the cover layer 60 includes a first piece of material 62 and a second piece of material 64. The first piece of material 62 and the second piece of material 64 are joined by a seam 66 with stitching 68. In other embodiments, the cover layer 60 may be formed from a single piece of material having no seams, or three or more pieces of material with multiple seams 66. Similarly, while the illustrated embodiment includes a seam 66 that axially bisects the flexible door 34, other embodiments may have seams 66 in other configurations, including arcs, corners, lines and/or other shapes. The cover layer 60 is secured to the outer surface of the cushion 46 such that the cover layer 60 may flex with the cushion 46 while maintaining a substantially smooth (e.g., unwrinkled) appearance. The cover layer 60 may be secured to the outer surface of the cushion 46 with an adhesive connection, or via a molding process.

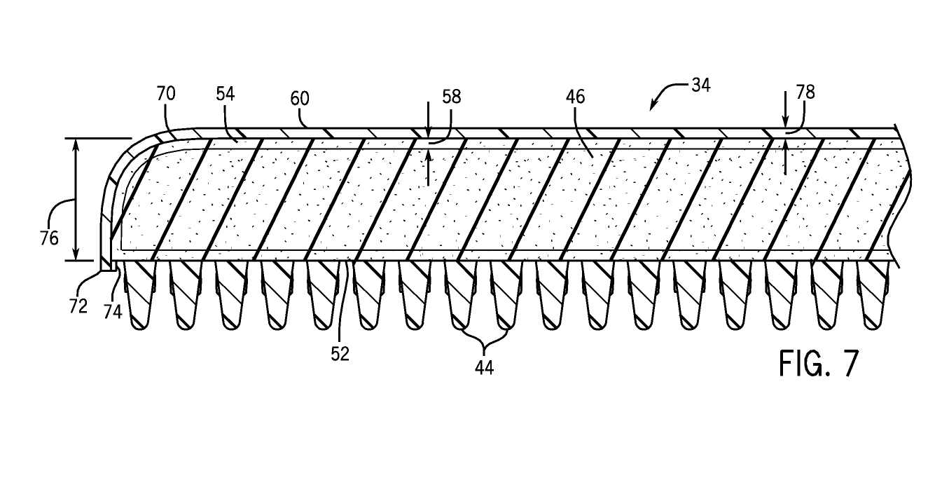

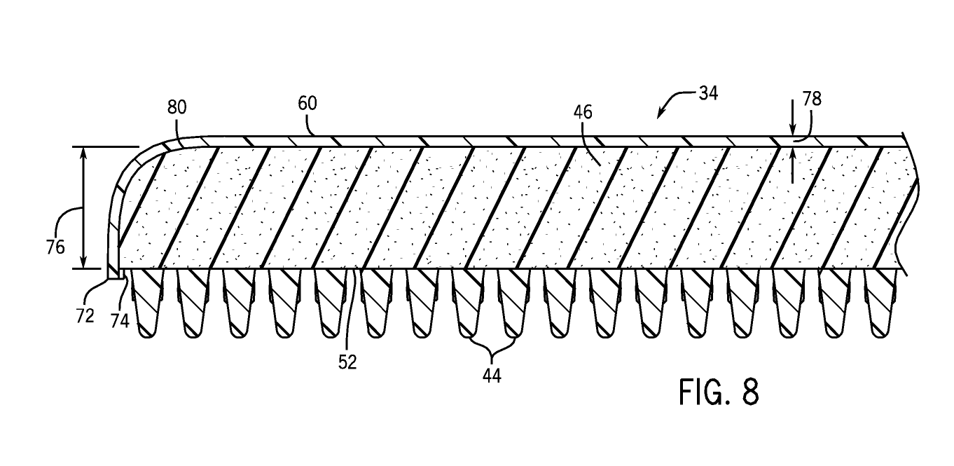

FIG. 7 is a cross-sectional view of the flexible tambour door of FIG. 6, taken along line 7-7. As illustrated, the ribs 44 are coupled to the rear surface 52 of the cushion 46 which faces the interior 42 of the console 16. As previously discussed, the ribs 44 may be formed by an injection molding process. Once the ribs 44 have been formed, the ribs 44 may be placed into a mold having a cavity shaped to form the cushion 46. Foam may then be poured into the mold. As the foam expands and cures, the foam bonds to the ribs 44, thereby forming a unitary structure including the ribs 44 and the cushion 46. In certain embodiments, the material chemistry as well as temperature variations within the mold may induce the formation of a high density flexible outer skin 54 around the low density foam cushion 46, as shown in FIG. 7. In such embodiments, the cover layer 60 may be secured to an outer surface 70 of the high density flexible outer skin 54. In certain embodiments, an edge 72 of the cover layer 60 may be folded under the cushion 46 and secured to the rear surface 52 of the cushion 46, or the ribs 44, with a fastener 74. For example, the fastener 74 may be a staple or pin.

A thickness 76 of the cushion 46 may be configured to facilitate bending of the door 34 in a direction substantially perpendicular to an orientation of the substantially parallel ribs 44, while establishing a cushioned core suitable for use as a vehicle armrest. As will be appreciated, thicker cushions 46 may provide an armrest with enhanced comfort, while thinner cushions 46 facilitate additional flexibility. Furthermore, the cover layer 60 may be manufactured from a material such as leather, vinyl, or cloth to provide a surface suitable for use as a show surface of an armrest. By way of example, in certain embodiments, the thickness 76 may be greater than approximately 5 mm. For example, the thickness 76 may be approximately between 5 to 20, 7 to 16, 8 to 11, or about 9 mm. In addition, for cushions 46 having the integral outer skin 54, a thickness 58 of the integral outer skin 54 may be particularly selected to enable the skin to flex as the cushion 46 is compressed. For example, the thickness 58 of the integral outer skin 54 may be less than approximately 2, 1.5, 1, 0.5, 0.3, 0.2, or 0.1 mm, or less. Moreover, a thickness 78 of the cover layer 60 may also be selected to enable the cover layer 60 to flex as the cushion 46 is compressed. For example, the thickness 78 may be approximately 2, 1.5 or 1.0 mm, or less.

FIG. 8 is a cross-sectional view of a further embodiment of a flexible tambour door with a cover layer, having a cushion without an integral outer skin. In the illustrated embodiment, the cushion 46 is formed from various foam compounds and/or molding processes that do not cause a high density outer skin to be formed around the low density foam cushion 46. Rather, the entire cushion 46 may have a substantially uniform low density. In such embodiments, the cover layer 60 may be secured to an outer surface 80 of the low density foam cushion 46. For example, the cover layer 50 may be secured to the outer surface 80 of the cushion 46 by an adhesive connection or via a molding process.

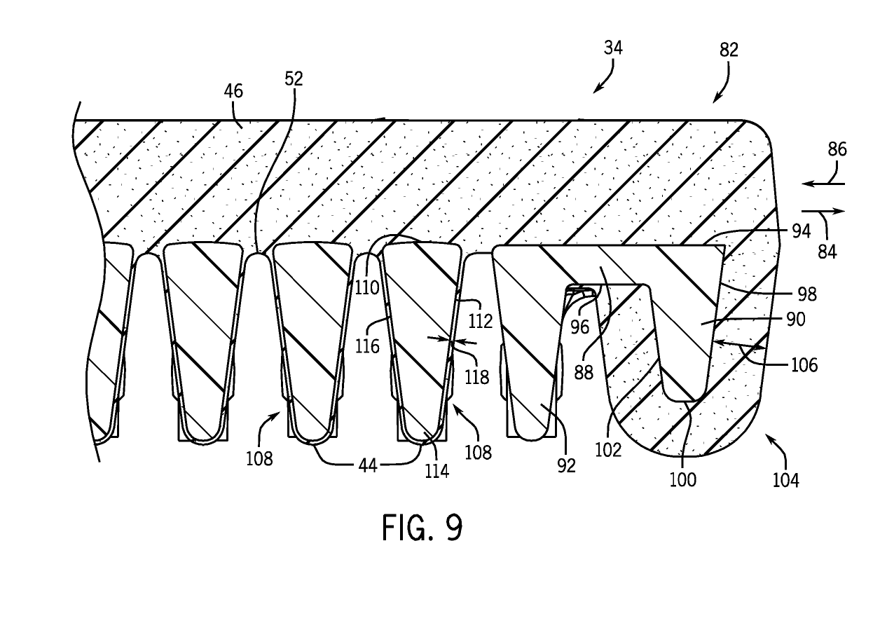

FIG. 9 is a cross-sectional view of an embodiment of a flexible tambour door 34 having a cushion that wraps around an axial end of a substrate, thereby establishing a padded axial end 82 of the tambour door. In certain embodiments, the tambour door 34 door is configured to slide in a first axial direction 84 from a closed position that substantially encloses a storage compartment to an open position that facilitates access to the storage compartment. In such embodiments, the tambour door 34 is also configured to slide in a second axial direction 86, opposite the first axial direction 84, from the open position to the closed position. In the illustrated embodiment, the cushion forms a padded leading axial end 82 relative to the first axial direction 84. However, it should be appreciated that the cushion may also form a padded trailing axial end relative to the first axial direction 84 (i.e., a leading axial end relative to the second axial direction 86).

In the illustrated embodiment, the tambour door 34 includes a substrate 88 having a first rib 90 positioned adjacent to the axial end 82 of the tambour door 34. Accordingly, the first rib 90 forms an axial end of the substrate that corresponds to the axial end 82 of the tambour door. Similar to the embodiments described above, the tambour door 34 also includes multiple second ribs 44 oriented substantially parallel to the first rib 90. Furthermore, the substrate includes a third rib 92 axially spaced from the first rib 90 along the second direction 86. Each rib is configured to engage a track to facilitate movement of the tambour door in the first and second axial directions. In addition, the substrate 88 and each second rib 44 is coupled to the cushion 46 to form a unitary tambour door structure.

In the illustrated embodiment, the cushion 46 extends along a first surface 94 of the substrate 88, wraps around the first rib 90, and engages a second surface 96 of the substrate. As the cushion 46 wraps around the first rib 90, the cushion contacts a leading surface 98 of the rib, a bottom surface 100 of the rib, and trailing surface 102 of the rib. In the illustrated embodiment, the leading surface 98 of first rib 90 forms the axial end of the substrate. As illustrated, wrapping the cushion 46 around the first rib 90 of the substrate 88 establishes a padded end portion 104 of the axial end 82 of the tambour door 34. Due to the increased contact area associated with wrapping the cushion 46 around the first rib 90, the bonding force between the cushion and the substrate may be greater than configurations in which the cushion is only coupled to the first surface of the substrate. As a result, the possibility of substrate/cushion separation during operation of the tambour door is substantially reduced or eliminated. In addition, because the cushion substantially covers the axial end of the substrate, the possibility of contact between an occupant hand and the substrate material is substantially reduced, thereby enhancing the perceived quality of the tambour door.

As will be appreciated, a thickness 106 of the cushion 46 that surrounds the first rib may be particularly selected to provide the desired strength, appearance, and/or feel. For example, in certain embodiments, the thickness 106 of the cushion around the first rib 90 may be substantially equal to the thickness of the cushion along the first surface 94 of the substrate. Alternatively, the portion of the cushion that surrounds the first rib may be thicker or thinner than the portion of the cushion that extends along the first surface 94 of the substrate 88. By way of example, the thickness 106 may be approximately between 0.25 to 20, 1 to 15, 5 to 10, or about 9 mm.

In the illustrated embodiment, each second rib 44 is encapsulated within the cushion 46 to enhance the bonding strength between the rib and the cushion. Accordingly, a foam layer 108 extends from the rear surface 52 of the cushion 46, wraps around the rib 44, and returns to the rear surface 52 of the cushion. For example, in the illustrated embodiment, a top surface 110 of the rib 44 is bonded to the rear surface 52 of the cushion 46. The foam layer 108 extends from the rear surface 52 of the cushion along a first axial surface 112 of the rib, wraps around a bottom surface 114 of the rib, and extends along a second axial surface 116 of the rib to the rear surface 52 of the cushion. Due to the enhanced contact area associated with the foam layer 108 extending about each rib, the bonding force between the ribs and the cushion may be greater than the bonding force in configurations in which the cushion is only coupled to the top surface 110 of each rib 44. As a result, the possibility of rib/cushion separation during operation of the tambour door is substantially reduced or eliminated.

As will be appreciated, a thickness 118 of the foam that surrounds the second ribs 44 may be particularly selected to provide the desired strength and/or appearance. For example, in certain embodiments, the thickness 118 of the foam layer 108 may be approximately between 0.1 to 1.0, 0.2 to 0.8, 0.25 to 0.5, or about 0.25 mm. In certain embodiments, the foam layer 108 may extend along an entire lateral extent of each rib. Alternatively, the foam layer 108 may extend along a portion of the lateral extent of the ribs. For example, in certain embodiments, multiple strips of foam, laterally spaced from one another, may extend axially along the ribs.

As discussed in detail below, the cushion 46 may be formed by a molding process. For example, the ribs may be secured within corresponding recesses of a first mold element. Two reactive foam compounds may be mixed and poured into a mold cavity of a second mold element. The two mold element may be brought into contact with one another such that the mold cavity is positioned adjacent to the ribs. As the foam expands and cures, the foam bonds to the ribs 44, thereby forming a unitary flexible component. To establish the foam layer around the ribs, the recesses may be sized slightly larger than the ribs. Accordingly, as the foam expands and cures, the foam flows into the gaps between the ribs and the corresponding recesses, thereby encapsulating each rib within the cushion.

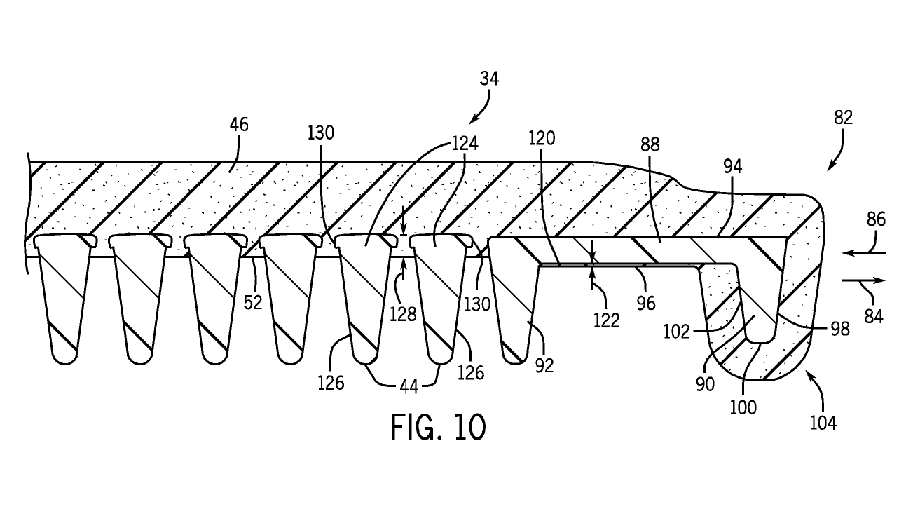

FIG. 10 is a cross-sectional view of another embodiment of a flexible tambour door having ribs partially embedded within a cushion. Similar to the embodiment described above with reference to FIG. 9, the tambour door 34 includes a cushion 46 wrapped around the first rib 90 of the substrate 88. In the illustrated embodiment, the cushion 120 extends along the second surface 96 of the substrate to block coating material from adhering to the substrate 88. As previously discussed, during the cushion molding process, a layer of paint may be applied to the mold cavity before the foam compounds are injected. The paint bonds with the foam adjacent to the inner surface of the mold, thereby establishing a desired color of the flexible outer skin. However, if portions of the substrate are exposed to the paint while the tambour door is in the mold, the paint may partially adhere to the substrate. However, during operation of the tambour door, the paint on the substrate may become dislodged, thereby reducing the perceived quality of the tambour door. By providing the cushion extension 120 over the second surface 96 of the substrate, the possibility of paint adhering to the substrate 88 in the mold is substantially reduced or eliminated, thereby enhancing the perceived quality of the tambour door.

As will be appreciated, a thickness 122 of the foam that extends along the second surface of the substrate may be particularly selected to provide the desired degree of protection from the foam paint. For example, in certain embodiments, the thickness 122 of the cushion extension 120 may be approximately between 0.1 to 1.0, 0.2 to 0.8, 0.25 to 0.5, or about 0.25 mm. Furthermore, it should be appreciated that other regions of the substrate (e.g., the third rib 92) may also be coated with a thin layer of foam to block coating material from adhering to the substrate.

In the illustrated embodiment, a portion of each rib 44 is embedded within the rear surface 52 of the cushion 46, thereby enhancing the bonding force between the ribs and the cushion. As illustrated, each rib 44 includes a first portion 124 embedded within the cushion 46, and a second portion 126 extending from the substrate. Accordingly, in the illustrated embodiment, only a portion of each rib 44 is embedded within the cushion 46. The first portion 124 extends within the cushion by a penetration depth 128. As will be appreciated, the penetration depth 128 may be particularly selected to provide the desired bonding strength between the ribs and the cushion. For example, the penetration depth 128 may be approximately between 0.5 to 10, 1 to 8, 3 to 6, or about 5 mm.

In the illustrated embodiment, the first portion 124 of each rib 44 includes a lateral extension 130 configured to establish a mechanical lock between the rib and the cushion. As will be appreciated, the length and/or geometry of the lateral extension 130 may be particularly selected to provide the desired bonding strength between the rib and the substrate. Furthermore, in the illustrated embodiment, the first portion 124 of each rib 44 is wider than the second portion 126 of the rib 44, thereby further strengthening the bond between the ribs and the cushion. However, it should be appreciated that that lateral extension 130 may be omitted in certain embodiments. In addition, other rib shapes may employed in alternative embodiments.

Because a portion of each rib is embedded within the cushion, contact between the first portion 124 and the foam of the cushion resists rotation of each rib relative to the cushion. Accordingly, the illustrated tambour door may resist higher vertical loads than tambour doors in which the cushion is only bonded to the top surface of each rib. Furthermore, it certain embodiments, a foam layer may extend about the periphery of each rib, similar to the embodiment described above with reference to FIG. 9, to further enhance the bonding between the rib and the cushion.

As previously discussed, the cushion 46 may be formed by a molding process. For example, the ribs may be secured within corresponding recesses of a first mold element. Two reactive foam compounds may be mixed and poured into a mold cavity of a second mold element. The two mold element may be brought into contact with one another such that the mold cavity is positioned adjacent to the ribs. As the foam expands and cures, the foam bonds to the ribs 44, thereby forming a unitary flexible component. To embed the ribs within the cushion, the ribs may be secured within a mold element having recesses shallower than the height of the corresponding ribs. Accordingly, as the foam expands and cures, the foam substantially covers the first portion of each rib, thereby embedding the ribs within the cushion.

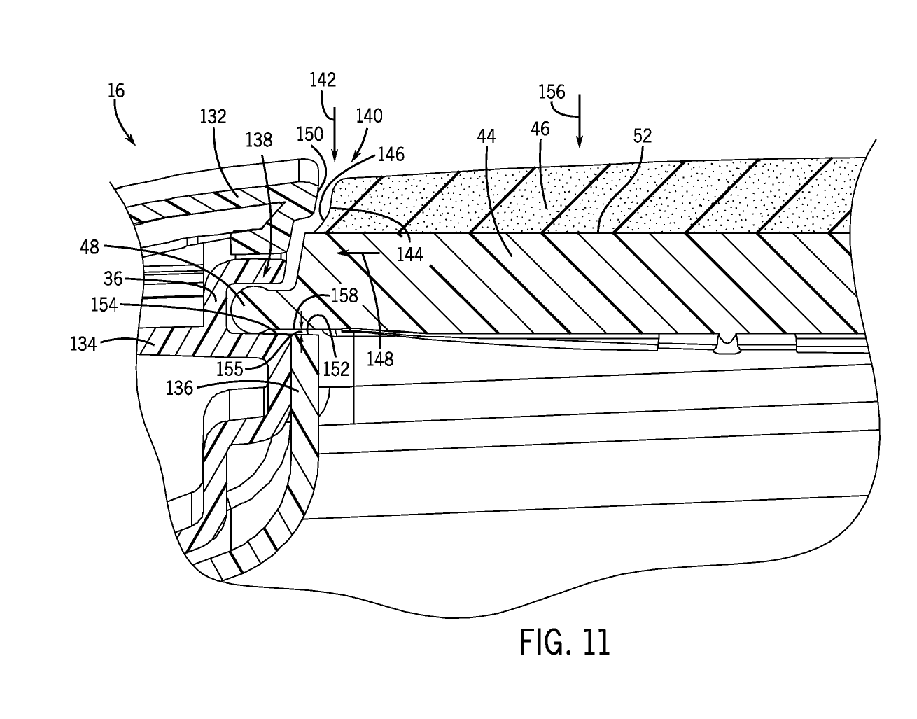

FIG. 11 is a cross-sectional view of a further embodiment of a flexible tambour door including a cushion having a contoured lateral end. In the illustrated embodiment, the tambour door 34 is mounted within a center console 16 that surrounds the tambour door 34. As illustrated, a cushion 132 of the center console 16 is disposed about the tambour door 34, and is substantially vertically aligned with the tambour door 34. In this configuration, an occupant may rest an arm on the padding of the tambour door cushion 46 and/or the padding of the center console cushion 132. In the illustrated embodiment, the center console cushion 132 is supported by a structural framework 134. The structural framework 134 also supports an interior wall 136 that defines a storage compartment of the center console 16. Furthermore, the structural framework 134 includes a C-shaped channel 138 that defines the track 36. Accordingly, the tambour door 34 may slide between an open position that facilitates access to the storage compartment and a closed position that substantially encloses the storage compartment via axial movement of the tambour door 34 along the track 36.

In the illustrate embodiment, the tambour door cushion 46 is spaced from the center console cushion 132 by a gap 140 that facilitates movement of the tambour door along the axial direction. Unfortunately, the gap may enable an occupant looking in the direction 142 to observe the interior structure of the center console/tambour door. Accordingly, the cushion 46 of the illustrated tambour door 34 includes a contoured lateral end 144 configured to block a line of sight to the interior of the console/tambour door, thereby enhancing the appearance of the center console. As illustrated, the contoured lateral end 144 forms a projection 146 adjacent to the rear surface 52 of the cushion 46. The projection 146 extends in a laterally outward direction 148 beyond an inner surface 150 of the center console cushion 132. Due to the overlap between the center console cushion 132 and the tambour door cushion 46, an occupant looking in the direction 142 may not be able to observe the interior structure of the center console. As a result, the appearance of the center console/tambour door may be enhanced.

Furthermore, the wall 136 that defines the storage compartment is configured to support the tambour door 34 during vertical loading. As illustrated, a distal end 152 of the wall 136 is positioned adjacent to the track 36. In the illustrated embodiment, the distal end 152 of the wall 136 is substantially flat, and substantially aligned with a bottom surface 154 of the track. Accordingly, a gap 155 is formed between the ribs 44 and the distal end 152 of the wall 136, thereby enabling the tambour door 34 to slide in the axial direction between the open and closed positions. However, when a downward vertical load is applied to the tambour door in the direction 156, the ribs may flex such that a bottom surface 158 of each rib 44 contacts the distal end 152 of the wall 136. Contact between the distal end 152 of the wall 136 and the ribs 44 supports the tambour door 34 during loading, thereby substantially reducing or eliminating the possibility of the ribs disengaging the track 36. As a result, the distal end of the wall blocks movement of the tambour door toward the storage compartment while the tambour door is subjected to a vertical load, such as from an occupant transferring weight to the tambour door. While the distal end 152 of the wall 136 is substantially flat in the illustrated embodiment, it should be appreciated that the distal end may be contoured in alternative embodiments (e.g., to match the contours of the ribs).

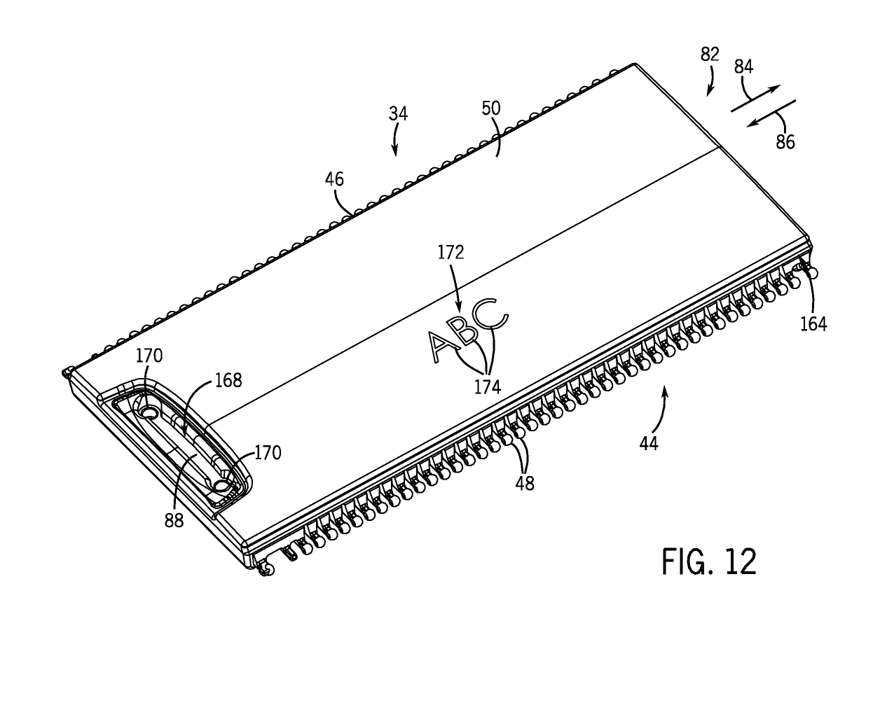

FIG. 12 is a perspective view of another embodiment of a flexible tambour door having a decoration formed within a show surface. In the illustrated embodiment, the cushion 46 includes an opening 168 that extends from the show surface 50 to the substrate 88. The opening 168 enables a handle to be directly secured to the substrate 88 (i.e., without a foam layer positioned between the handle and the substrate). As a result, a tighter/more secure bond may be established between the handle and the substrate, thereby enhancing the perceived quality of the tambour door. In the illustrated embodiment, the substrate 88 includes openings 170 configured to accommodate fasteners for securing the handle to the substrate. However, it should be appreciated that the handle may be secured to the substrate by other methods, such as adhesive bonding or heat-staking, for example.

In the illustrated embodiment, the cushion 46 includes an integral outer skin, such as the skin described above with reference to FIGS. 4-5. In addition, the tambour door includes a decoration 172 formed within a first show surface 50 of the integral outer skin. The decoration 172 includes a second show surface 174 that defines the boundaries of the decoration 172. In the illustrated embodiment, a first height of the first show surface 50 relative to the ribs is different than a second height of the second show surface 174 relative to the ribs. As a result, the boundaries of the decoration 172 are clearly defined. For example, the second height may be less than the first height, thereby forming an embossed decoration. Alternatively, the second height may be greater than the first height, thereby forming a raised decoration. In certain embodiments, a cover layer may be disposed over the raised decoration, thereby establishing a visible pattern in the cover layer. In addition, a decorative coating may be applied to the decoration to further enhance the appearance of the tambour door. As will be appreciated, a height, size, and/or shape of the decoration may be particularly selected to provide a desired tambour door appearance.

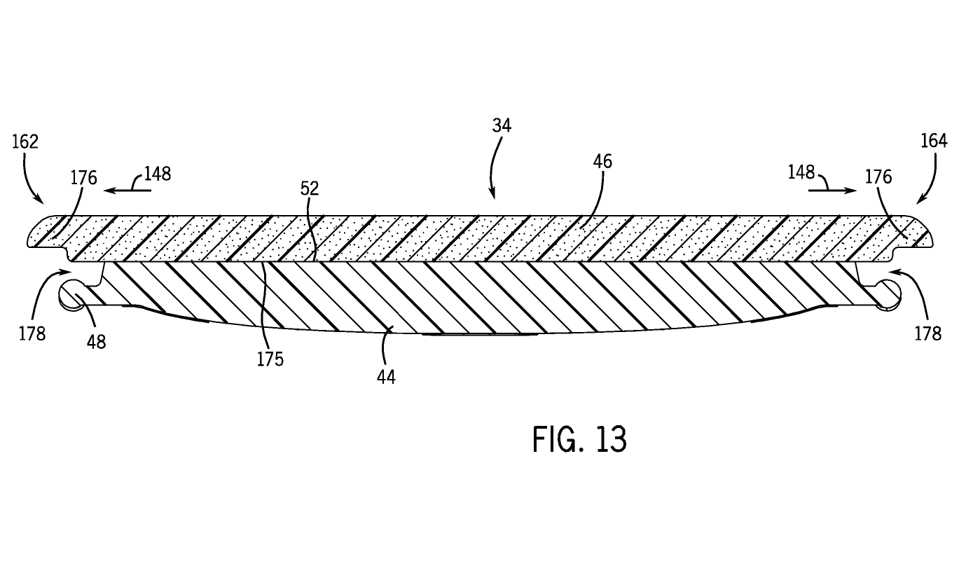

FIG. 13 is a cross-sectional view of a further embodiment of a flexible tambour door having a cushion that extends laterally outward beyond a mounting surface of each supporting rib. As illustrated, the rear surface 52 of the cushion 46 is coupled to a mounting surface 175 of each rib 44. In addition, the cushion 46 includes a lateral projection 176 spaced from the rib protrusions 48, and extending beyond the mounting surface 175 in the laterally outward direction 148. As a result, a recess 178 is formed between the protrusions 48 and the lateral projection 176. Similar to the embodiment described above with reference to FIG. 11, the lateral projection 176 blocks a line of sight into the interior structure of the center console, thereby enhancing the appearance of the console/tambour door. In certain embodiments, the lateral projection 176 may overlap a top surface of the surrounding center console structure, thereby obviating the cushion 132. As a result, the cost and/or complexity of the center console may be reduced.

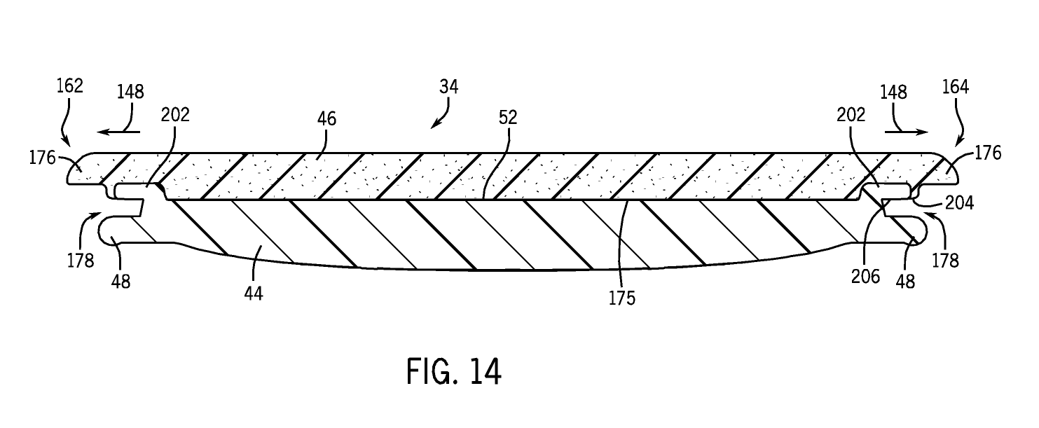

FIG. 14 is a cross-sectional view of an embodiment of a flexible tambour door having a supporting rib with a mounting feature embedded within a rear surface of a cushion. Similar to the embodiment described above with reference to FIG. 13, the cushion 46 includes a lateral projection 176 spaced from the rib protrusions 48, and extending beyond the mounting surface of each rib in the laterally outward direction 148. As a result, the lateral projection 176 blocks a line of sight into the interior structure of the center console, thereby enhancing the appearance of the console/tambour door. In the illustrated embodiment, each rib 44 includes a mounting feature 202 embedded within the rear surface 52 of the cushion 46. As illustrated, a portion 204 of the cushion 46 extends along a bottom surface 206 of the mounting feature 202, thereby establishing a mechanical lock between the rib 44 and the cushion 46. Because the mounting feature 202 supports the lateral projection 176 of the cushion, the lateral ends of the cushion 46 may resist additional loading, thereby providing a more durable tambour door, and/or enabling the cushion to extend a greater lateral distance beyond the mounting surface of each rib.

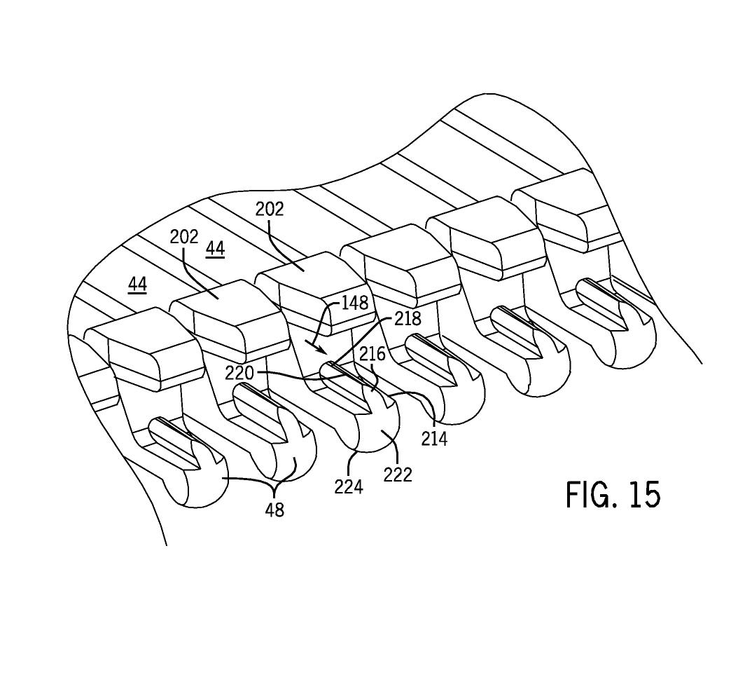

FIG. 15 is a detailed perspective view of an embodiment of protrusions that extend from ribs 44 of the tambour door 34. In the illustrated embodiment, each protrusion 48 includes a first portion 214 and a second portion 216, each formed during an injection molding process. As illustrated, the second portion 216 is narrower than the first portion 214 (i.e., the axial extent of the second portion 216 is less than the axial extent of the first portion 214). In addition, a top surface 218 of the second potion 216 is substantially flat. In the illustrated embodiment, the protrusion 48 is configured to contact the track at a first point 220 along the top surface 218 of the second portion 216, at a second point 222 at a lateral end of the first portion 214, and at a third point 224 at a bottom end of the first portion 214. The three points of contact block lateral and vertical movement of the tambour door relative to the center console, while enabling the tambour door to move in the axial direction between the open and closed positions.

In certain embodiments, a surface energy of the ribs and/or the substrate may be particularly selected to establish a suitable bond with the cushion. For example, in certain embodiments, the ribs and/or substrate may be formed from a material having a surface energy greater than 30, 40, 50, or 60 dynes/cm, or more. For example, the ribs and/or substrate may be formed from polycarbonate, acrylonitrile butadiene styrene, and/or polyamide. Alternatively, the ribs and/or substrate may be treated (e.g., via flame treatment, plasma treatment, chemical treatment, etc.) to increase the surface energy to a desired level.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1-10. (canceled)

11. An interior trim component, comprising:
a plurality of substantially parallel ribs each configured to engage a track to facilitate movement of the interior trim component along the track; and
a cushion having an outer surface and a rear surface, wherein the outer surface is configured to face an interior of a vehicle, and the rear surface is coupled to the plurality of substantially parallel ribs;
wherein a portion of at least one first rib of the plurality of substantially parallel ribs is embedded within the rear surface, or at least one second rib of the plurality of substantially parallel ribs is encapsulated within the cushion.

12. The interior trim component of claim 11, wherein the portion of the at least one first rib comprises a lateral extension configured to establish a mechanical lock between the at least one first rib and the cushion.

13. The interior trim component of claim 11, wherein the portion of the at least one first rib is wider than a remainder of the at least one first rib.

14. The interior trim component of claim 11, wherein each rib of the plurality of substantially parallel ribs is formed from a material having a surface energy greater than 40 dynes/cm.

15. The interior trim component of claim 11, wherein the interior trim component comprises a tambour door configured to substantially enclose a storage compartment.

16-20. (canceled)

21. An interior trim component comprising:
a plurality of substantially parallel ribs, and a corresponding plurality of protrusions extending laterally outward from the plurality of substantially parallel ribs, wherein each protrusion of the corresponding plurality of protrusions is configured to engage a track to facilitate movement of the interior trim component along the track; and
a cushion having an outer surface and a rear surface, wherein the outer surface is configured to face an interior of a vehicle, and the rear surface is coupled to a mounting surface of each rib of the plurality of substantially parallel ribs;
wherein the cushion comprises a lateral projection spaced from the plurality of protrusions, and extending laterally outward beyond the mounting surface of each rib of the plurality of substantially parallel ribs.

22. The interior trim component of claim 21, wherein at least one rib of the plurality of substantially parallel ribs comprises a mounting feature embedded within the rear surface of the cushion to establish a mechanical lock between the at least one rib and the cushion.

23. (canceled)

24. The interior trim component of claim 21, wherein the cushion includes an integral outer skin.

25. An interior trim component, comprising:
a plurality of substantially parallel ribs each configured to engage a track to facilitate movement of the interior trim component along the track;
a cushion having an integral outer skin, wherein the cushion is coupled to the plurality of substantially parallel ribs, and the integral outer skin forms a first show surface of the interior trim component; and
a decoration formed within the integral outer skin, wherein the decoration includes a second show surface, and a first height of the first show surface relative to the plurality of substantially parallel ribs is different than a second height of the second show surface relative to the plurality of substantially parallel ribs.

26. The interior trim component of claim 25, wherein the second height is greater than the first height.

27. The interior trim component of claim 26, wherein the integral outer skin is configured to receive a cover layer over the decoration.

28. The interior trim component of claim 25, wherein the second show surface is configured to receive a decorative coating layer.

29. The interior trim component of claim 25, wherein the interior trim component comprises a tambour door configured to substantially enclose a storage compartment.

30. The interior trim component of claim 25, wherein each rib of the plurality of substantially parallel ribs is formed from a material having a surface energy greater than 40 dynes/cm.

31. The interior trim component of claim 11, comprising a substrate having an additional rib positioned adjacent to an axial end of the interior trim component, wherein the additional rib is configured to engage the track to facilitate movement of the interior trim component along the track;
wherein the cushion extends along a first surface of the substrate, wraps around the additional rib, and engages a second surface of the substrate, opposite the first surface, to form the axial end of the interior trim component.

32. The interior trim component of claim 31, wherein the cushion includes an opening adjacent to the first surface to facilitate securing a handle to the substrate.

33. The interior trim component of claim 31, wherein the cushion extends along the second surface of the substrate to block coating material from adhering to the substrate.

34. The interior trim component of claim 11, wherein a foam layer of the cushion extends from the rear surface, wraps around the at least one second rib, and returns to the rear surface.

35. The interior trim component of claim 21, wherein each rib of the plurality of substantially parallel ribs is formed from a material having a surface energy greater than 40 dynes/cm.

36. The interior trim component of claim 21, wherein the interior trim component comprises a tambour door configured to substantially enclose a storage compartment.
